(19) United States
(12) Patent Application Publication
(10) Pub. No.: US 2026/0136400 A1
(43) Pub. Date: May 14, 2026

(54) INTERPRETATION FOR PHYSICAL DOWNLINK CONTROL CHANNEL ORDER ADAPTING PHYSICAL RANDOM ACCESS CHANNEL RESOURCES

(71) Applicant: QUALCOMM Incorporated, San Diego, CA (US)

(72) Inventors: Ahmed Attia ABOTABL, San Diego, CA (US); Hung Dinh LY, San Diego, CA (US)

(21) Appl. No.: 18/944,190

(22) Filed: Nov. 12, 2024

(51) Int. Cl. H04W 74/0833; H04W 72/23

(52) U.S. Cl. CPC H04W 74/0833; H04W 72/23

(57) ABSTRACT

Various aspects of the present disclosure generally relate to wireless communication. In some aspects, a user equipment (UE) may receive, from a network node, a default physical random access channel (PRACH) configuration that indicates one or more default PRACH resources. The UE may receive, from the network node, an additional PRACH configuration that configures one or more additional PRACH resources. The UE may receive, from the network node, a physical downlink control channel (PDCCH) order that initiates a random access channel (RACH) procedure and indicates a subset of the one or more additional PRACH resources to activate. The UE may transmit, to the network node, a PRACH message using a PRACH resource selected from the one or more default PRACH resources and the subset of the one or more additional PRACH resources in accordance with the PDCCH order. Numerous other aspects are described.

### FIELD OF THE DISCLOSURE

Aspects of the present disclosure generally relate to wireless communication and specifically relate to techniques, apparatuses, and methods associated with an interpretation for a physical downlink control channel order adapting physical random access channel resources.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a user equipment (UE) for wireless communication. The UE may include one or more memories and one or more processors coupled to the one or more memories. The one or more processors may be configured to receive, from a network node, a default physical random access channel (PRACH) configuration that indicates one or more default PRACH resources. The one or more processors may be configured to receive, from the network node, an additional PRACH configuration that configures one or more additional PRACH resources. The one or more processors may be configured to receive, from the network node, a physical downlink control channel (PDCCH) order that initiates a random access channel (RACH) procedure and indicates a subset of the one or more additional PRACH resources to activate. The one or more processors may be configured to transmit, to the network node, a PRACH message using a PRACH resource selected from the one or more default PRACH resources and the subset of the one or more additional PRACH resources in accordance with the PDCCH order.

Some aspects described herein relate to a network node for wireless communication. The network node may include one or more memories and one or more processors coupled to the one or more memories. The one or more processors may be configured to transmit, to a UE, a default PRACH configuration that indicates one or more default PRACH resources. The one or more processors may be configured to transmit, to the UE, an additional PRACH configuration that configures one or more additional PRACH resources. The one or more processors may be configured to transmit, to the UE, a PDCCH order that initiates a RACH procedure and indicates a subset of the one or more additional PRACH resources to activate. The one or more processors may be configured to receive, from the UE, a PRACH message using a PRACH resource selected from the one or more default PRACH resources and the subset of the one or more additional PRACH resources in accordance with the PDCCH order.

Some aspects described herein relate to a method of wireless communication performed by a UE. The method may include receiving, from a network node, a default PRACH configuration that indicates one or more default PRACH resources. The method may include receiving, from the network node, an additional PRACH configuration that configures one or more additional PRACH resources. The method may include receiving, from the network node, a PDCCH order that initiates a RACH procedure and indicates a subset of the one or more additional PRACH resources to activate. The method may include transmitting, to the network node, a PRACH message using a PRACH resource selected from the one or more default PRACH resources and the subset of the one or more additional PRACH resources in accordance with the PDCCH order.

Some aspects described herein relate to a method of wireless communication performed by a network node. The method may include transmitting, to a UE, a default PRACH configuration that indicates one or more default PRACH resources. The method may include transmitting, to the UE, an additional PRACH configuration that configures one or more additional PRACH resources. The method may include transmitting, to the UE, a PDCCH order that initiates a RACH procedure and indicates a subset of the one or more additional PRACH resources to activate. The method may include receiving, from the UE, a PRACH message using a PRACH resource selected from the one or more default PRACH resources and the subset of the one or more additional PRACH resources in accordance with the PDCCH order.

Some aspects described herein relate to a non-transitory computer-readable medium that stores a set of instructions for wireless communication by a UE. The set of instructions, when executed by one or more processors of the UE, may cause the UE to receive, from a network node, a default PRACH configuration that indicates one or more default PRACH resources. The set of instructions, when executed by one or more processors of the UE, may cause the UE to receive, from the network node, an additional PRACH configuration that configures one or more additional PRACH resources. The set of instructions, when executed by one or more processors of the UE, may cause the UE to receive, from the network node, a PDCCH order that initiates a RACH procedure and indicates a subset of the one or more additional PRACH resources to activate. The set of instructions, when executed by one or more processors of the UE, may cause the UE to transmit, to the network node, a PRACH message using a PRACH resource selected from the one or more default PRACH resources and the subset of the one or more additional PRACH resources in accordance with the PDCCH order.

Some aspects described herein relate to a non-transitory computer-readable medium that stores a set of instructions for wireless communication by a network node. The set of instructions, when executed by one or more processors of the network node, may cause the network node to transmit, to a UE, a default PRACH configuration that indicates one or more default PRACH resources. The set of instructions, when executed by one or more processors of the network node, may cause the network node to transmit, to the UE, an additional PRACH configuration that configures one or more additional PRACH resources. The set of instructions, when executed by one or more processors of the network node, may cause the network node to transmit, to the UE, a PDCCH order that initiates a RACH procedure and indicates a subset of the one or more additional PRACH resources to activate. The set of instructions, when executed by one or more processors of the network node, may cause the network node to receive, from the UE, a PRACH message using a PRACH resource selected from the one or more default PRACH resources and the subset of the one or more additional PRACH resources in accordance with the PDCCH order.

Some aspects described herein relate to an apparatus for wireless communication. The apparatus may include means for receiving, from a network node, a default PRACH configuration that indicates one or more default PRACH resources. The apparatus may include means for receiving, from the network node, an additional PRACH configuration that configures one or more additional PRACH resources. The apparatus may include means for receiving, from the network node, a PDCCH order that initiates a RACH procedure and indicates a subset of the one or more additional PRACH resources to activate. The apparatus may include means for transmitting, to the network node, a PRACH message using a PRACH resource selected from the one or more default PRACH resources and the subset of the one or more additional PRACH resources in accordance with the PDCCH order.

Some aspects described herein relate to an apparatus for wireless communication. The apparatus may include means for transmitting, to a UE, a default PRACH configuration that indicates one or more default PRACH resources. The apparatus may include means for transmitting, to the UE, an additional PRACH configuration that configures one or more additional PRACH resources. The apparatus may include means for transmitting, to the UE, a PDCCH order that initiates a RACH procedure and indicates a subset of the one or more additional PRACH resources to activate. The apparatus may include means for receiving, from the UE, a PRACH message using a PRACH resource selected from the one or more default PRACH resources and the subset of the one or more additional PRACH resources in accordance with the PDCCH order.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example of a four-step random access procedure, in accordance with the present disclosure.

FIG. 4 is a diagram illustrating an example of a two-step random access procedure, in accordance with the present disclosure.

FIG. 5 is a diagram illustrating an example associated with a physical downlink control channel (PDCCH) order adapting physical random access channel (PRACH) resources and an example associated with an interpretation for the PDCCH order, in accordance with the present disclosure.

FIG. 6 is a diagram illustrating an example call flow associated with a PDCCH order adapting PRACH resources, in accordance with the present disclosure.

FIG. 7 is a diagram illustrating an example process performed, for example, at a UE or an apparatus of a UE, in accordance with the present disclosure.

FIG. 8 is a diagram illustrating an example process performed, for example, at a network node or an apparatus of a network node, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Network energy savings and/or network energy efficiency measures are expected to have increased importance in wireless network operations for various reasons, such as climate change mitigation, environmental sustainability, and/or network cost reduction, among other examples. For example, although New Radio (NR) generally offers a significant energy efficiency improvement per gigabyte over previous generations (e.g., long term evolution (LTE)), some NR use cases and/or the adoption of millimeter wave frequencies may require more network sites, more network antennas, larger bandwidths, and/or more frequency bands, among other examples, which may lead to more efficient wireless networks that nonetheless have higher energy requirements and/or cause more emissions than previous wireless network generations. Furthermore, energy accounts for a significant proportion of the cost to operate a wireless network. For example, according to some estimates, energy costs are about one-fourth of the total cost to operate a wireless network, and most of the energy consumption and/or energy costs are associated with a radio access network (RAN), with data centers and fiber transport accounting for smaller shares. Accordingly, measures to increase network energy savings and/or improve network energy efficiency are factors that may drive adoption and/or expansion of wireless networks.

One technique to increase energy efficiency in a RAN is to enable adaptation for one or more physical random access channel (PRACH) parameters in a time domain. For example, a network node may generally provide a cell-wide PRACH configuration (e.g., in a system information block (SIB) or synchronization signal block (SSB)) that indicates various default PRACH parameters applicable to each user equipment (UE) in the cell and/or a UE-dedicated PRACH configuration that indicates default PRACH parameters applicable to one UE. For example, among other parameters, the default PRACH parameters may include one or more default PRACH resources (also known as

random access channel (RACH) occasions or ROs) that correspond to time and frequency resources where a UE may transmit a PRACH message (e.g., a msg1 to initiate a four-step RACH procedure or a msgA preamble to initiate a two-step RACH procedure). Furthermore, the network node may configure (e.g., via semi-static signaling) one or more additional PRACH resources for one or more UEs operating in a radio resource control (RRC) connected mode or an RRC idle/inactive mode, and the additional PRACH resources may initially be in a deactivated state. Accordingly, to enable network energy savings via PRACH adaptation in a time domain, the network node may always monitor the default PRACH resources (e.g., to detect PRACH messages from UEs attempting to acquire initial access to the cell), and may monitor the additional PRACH resources only when the additional PRACH resources have been activated. For example, the network node may dynamically activate the additional PRACH resources for a UE in an RRC connected mode or an RRC idle/inactive mode in a physical downlink control channel (PDCCH) order that triggers contention-based random access (CBRA) or contention-free random access (CFRA), and the network node may then monitor the dynamically activated PRACH resources for a PRACH message from the UE.

However, when a PDCCH order is used to trigger a RACH procedure for a UE in an RRC connected mode or an RRC idle/inactive mode, certain fields in the PDCCH order may be interpreted differently depending on whether the PDCCH order is triggering CBRA or CFRA. For example, when the PDCCH order triggers CFRA (e.g., to avoid collisions where multiple UEs transmit a PRACH message using the same preamble and the same RO), the PDCCH order may include several fields that indicate parameters for the PRACH message (e.g., a random access preamble index, an uplink carrier index, an SSB index, and/or a PRACH mask index). On the other hand, when the PDCCH order triggers CBRA, the UE has more flexibility to select the parameters for the PRACH message, and the random access preamble index field, the uplink carrier field, the SSB index field, and/or the PRACH mask index field are ignored. Accordingly, when a PDCCH order that triggers a RACH procedure for a UE is also used to activate additional PRACH resources, the UE may be unable to determine which additional PRACH resources are activated by the PDCCH order and/or how long the additional PRACH resources are activated, because the fields of the PDCCH order are interpreted differently depending on whether CBRA or CFRA is triggered.

Various aspects relate generally to an interpretation for a PDCCH order adapting PRACH resources. For example, a network node may provide a UE with a default PRACH configuration that indicates one or more default PRACH resources (e.g., via a SIB, SSB, or other cell-wide or UE-dedicated signaling) and one or more additional PRACH configurations that indicate one or more additional PRACH resources (e.g., via RRC or other semi-static signaling). In some aspects, the network node may transmit, to the UE, a PDCCH order that triggers a RACH procedure and indicates a subset of the additional PRACH resources to activate, and the UE may interpret the PDCCH order to determine the subset of the additional PRACH resources activated by the PDCCH order depending on whether the PDCCH order triggers CBRA or CFRA. For example, in cases where the PDCCH order triggers CBRA, such that one or more fields that are otherwise used to indicate CFRA parameters are reserved (unused), the PDCCH order may indicate the subset of the additional PRACH resources to activate and/or an activation window for the activated subset of the additional PRACH resources using the one or more reserved fields and/or one or more reserved bits associated with the PDCCH order. Alternatively, in cases where the PDCCH order triggers CFRA, such that the fields that indicate CFRA parameters are used, the PDCCH order may indicate the subset of the additional PRACH resources to activate and/or the activation window for the activated subset of the additional PRACH resources using only the reserved bits associated with the PDCCH order. Additionally, or alternatively, the network node may configure a semi-static parameter to indicate whether the PDCCH order can be used to activate additional PRACH resources and/or which additional PRACH resources can be activated by the PDCCH order, and/or allow implicit activation by the PDCCH order for additional PRACH resources that have been configured.

Particular aspects of the subject matter described in this disclosure can be implemented to realize one or more of the following potential advantages. In some examples, the described techniques can be used to provide, in a PDCCH order triggering a RACH procedure for a UE, an indication regarding which additional PRACH resources are activated and/or how long the additional PRACH resources are activated. In this way, the UE may identify the additional PRACH resources that are available to transmit a PRACH message to initiate the RACH procedure triggered by the PDCCH order. For example, the UE may determine how to interpret the PDCCH order depending on whether the PDCCH order triggers CBRA or CFRA, such that the UE may select a PRACH resource for transmitting the PRACH message from the default (cell-wide or UE-dedicated) PRACH resources that the network node always monitors and the additional PRACH resources that have been dynamically activated for the UE. In this way, the network node may conserve energy by always monitoring the default PRACH resources, and by temporarily monitoring additional PRACH resources only when the additional PRACH resources have been dynamically activated for one or more UEs.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G NR is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

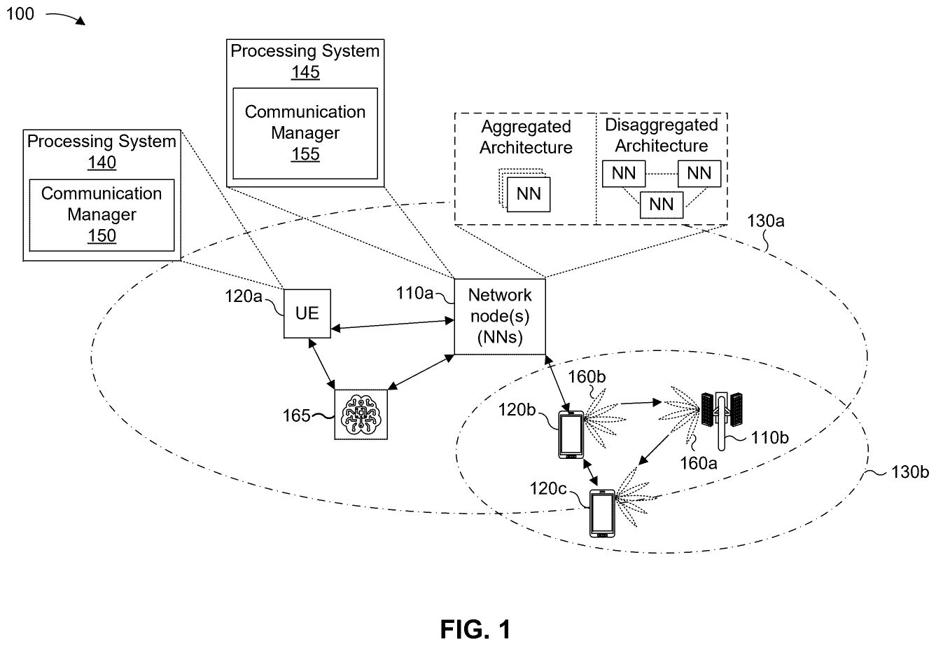

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

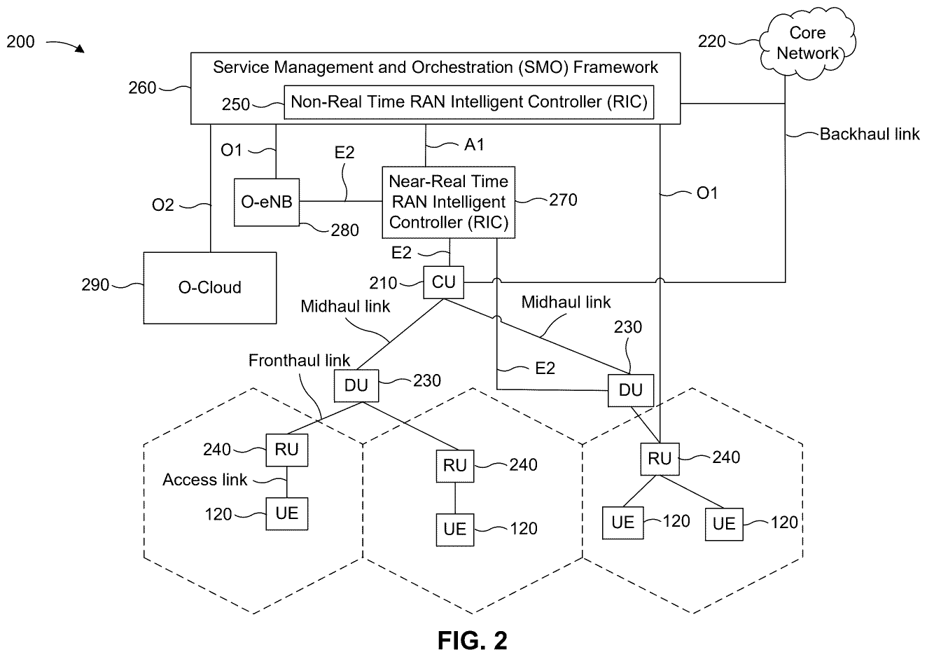

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or PRACH extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include PDCCHs, and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a RACH operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In some aspects, the UE 120 may include a communication manager 150. As described in more detail elsewhere herein, the communication manager 150 may receive, from a network node 110, a default PRACH configuration that indicates one or more default PRACH resources; receive, from the network node 110, an additional PRACH configuration that configures one or more additional PRACH resources; receive, from the network node 110, a PDCCH order that initiates a RACH procedure and indicates a subset of the one or more additional PRACH resources to activate; and transmit, to the network node 110, a PRACH message using a PRACH resource selected from the one or more default PRACH resources and the subset of the one or more additional PRACH resources in accordance with the PDCCH order. Additionally, or alternatively, the communication manager 150 may perform one or more other operations described herein.

In some aspects, the network node 110 may include a communication manager 155. As described in more detail elsewhere herein, the communication manager 155 may transmit, to a UE 120, a default PRACH configuration that indicates one or more default PRACH resources; transmit, to the UE 120, an additional PRACH configuration that configures one or more additional PRACH resources; transmit, to the UE 120, a PDCCH order that initiates a RACH procedure and indicates a subset of the one or more additional PRACH resources to activate; and receive, from the UE 120, a PRACH message using a PRACH resource selected from the one or more default PRACH resources and the subset of the one or more additional PRACH resources in accordance with the PDCCH order. Additionally, or alternatively, the communication manager 155 may perform one or more other operations described herein.

As indicated above, FIG. 1 is provided as an example. Other examples may differ from what is described with regard to FIG. 1.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

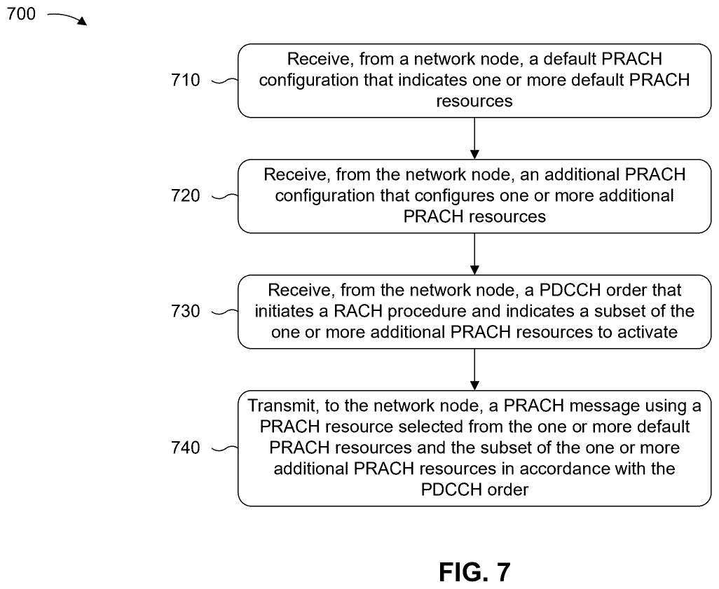

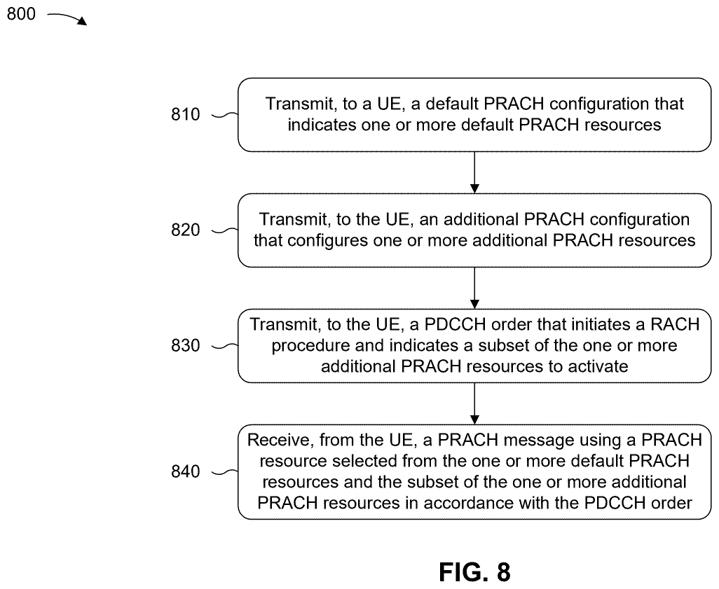

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with an interpretation for a PDCCH order adapting PRACH resources, as described in more detail elsewhere herein. For example, the processing system 145 of the network node 110, the processing system 140 of the UE 120, the CU 210, the DU 230, or the RU 240 may perform or direct operations of, for example, process 700 of FIG. 7, process 800 of FIG. 8, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 700 of FIG. 7, process 800 of FIG. 8, or other processes as described herein. In some examples, executing instructions may include running the instructions, converting the instructions, compiling the instructions, and/or interpreting the instructions, among other examples.

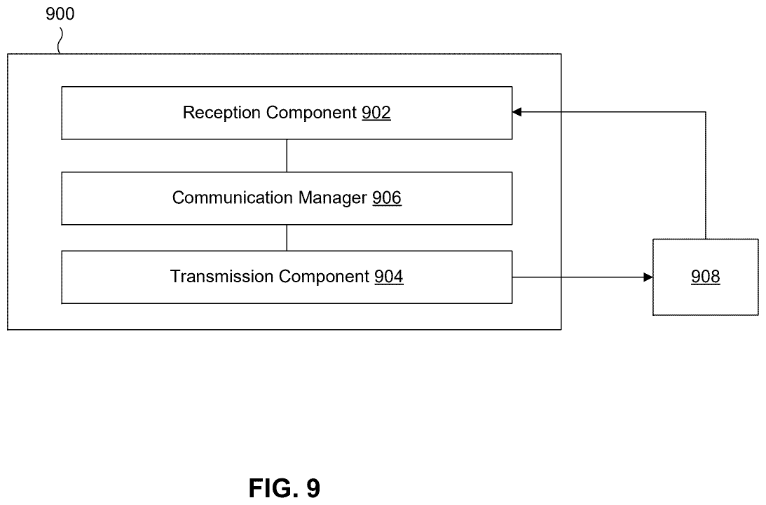

In some aspects, the UE 120 includes means for receiving, from a network node 110, a default PRACH configuration that indicates one or more default PRACH resources; means for receiving, from the network node 110, an additional PRACH configuration that configures one or more additional PRACH resources; means for receiving, from the network node 110, a PDCCH order that initiates a RACH procedure and indicates a subset of the one or more additional PRACH resources to activate; and/or means for transmitting, to the network node 110, a PRACH message using a PRACH resource selected from the one or more default PRACH resources and the subset of the one or more additional PRACH resources in accordance with the PDCCH order. The means for the UE 120 to perform operations described herein may include, for example, one or more of communication manager 150, processing system 140, a radio, one or more RF chains, one or more transceivers, one or more antennas, one or more modems, a reception component (for example, reception component 902 depicted and described in connection with FIG. 9), and/or a transmission component (for example, transmission component 904 depicted and described in connection with FIG. 9), among other examples.

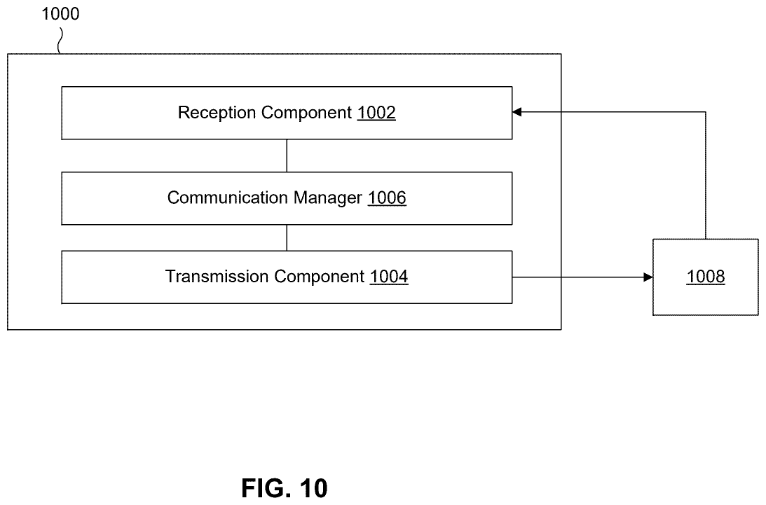

In some aspects, the network node 110 includes means for transmitting, to a UE 120, a default PRACH configuration that indicates one or more default PRACH resources; means for transmitting, to the UE 120, an additional PRACH configuration that configures one or more additional PRACH resources; means for transmitting, to the UE 120, a PDCCH order that initiates a RACH procedure and indicates a subset of the one or more additional PRACH resources to activate; and/or means for receiving, from the UE 120, a PRACH message using a PRACH resource selected from the one or more default PRACH resources and the subset of the one or more additional PRACH resources in accordance with the PDCCH order. The means for the network node 110 to perform operations described herein may include, for example, one or more of communication manager 155, processing system 145, a radio, one or more RF chains, one or more transceivers, one or more antennas, one or more modems, a reception component (for example, reception component 1002 depicted and described in connection with FIG. 10), and/or a transmission component (for example, transmission component 1004 depicted and described in connection with FIG. 10), among other examples.

As indicated above, FIG. 2 is provided as an example. Other examples may differ from what is described with regard to FIG. 2.

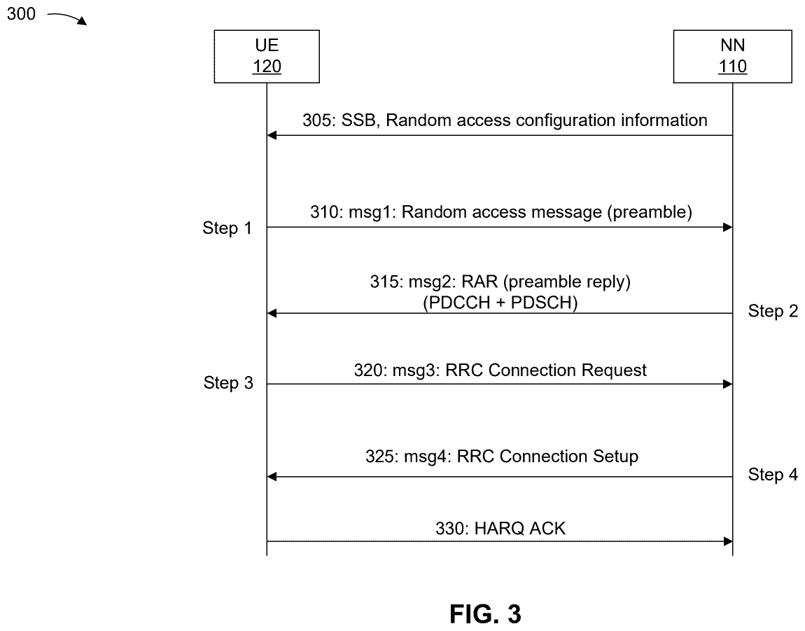

FIG. 3 is a diagram illustrating an example 300 of a four-step random access procedure, in accordance with the present disclosure. As shown in FIG. 3, a network node 110 and a UE 120 may communicate with one another to perform the four-step random access procedure.

As shown by reference number 305, the network node 110 may transmit, and the UE 120 may receive, one or more SSBs and random access configuration information. In some aspects, the random access configuration information may be transmitted in and/or indicated by system information (e.g., in one or more system information blocks (SIBs)) and/or an SSB, such as for CBRA. Additionally, or alternatively, the random access configuration information may be transmitted in an RRC message and/or a PDCCH order message that triggers a RACH procedure, such as for CFRA. The random access configuration information may include one or more parameters to be used in the random access procedure, such as one or more parameters for transmitting a RAM and/or one or more parameters for receiving an RAR responsive to the RAM (e.g., a PRACH configuration index that corresponds to a specific PRACH period, frequency and time resources associated with one or more ROs, a number of SSBs per RO and contention-based preambles per SSB, and/or a duration for an RAR response window, and/or among other examples).

As shown by reference number 310, the UE 120 may transmit a RAM, which may include a preamble (sometimes referred to as a random access preamble, a PRACH preamble, or a RAM preamble). The message that includes the preamble may be referred to as a message 1, msg1, MSG1, a first message, or an initial message in a four-step random access procedure. The random access message may include a RAPID.

As shown by reference number 315, the network node 110 may transmit an RAR as a reply to the preamble. The message that includes the RAR may be referred to as message 2, msg2, MSG2, or a second message in a four-step random access procedure. In some aspects, the RAR may indicate the detected RAPID (e.g., received from the UE 120 in msg1). Additionally, or alternatively, the RAR may indicate a resource allocation to be used by the UE 120 to transmit message 3 (msg3).

In some aspects, as part of the second step of the four-step random access procedure, the network node 110 may transmit a PDCCH communication for the RAR. The PDCCH communication may schedule a PDSCH communication that includes the RAR. For example, the PDCCH communication may indicate a resource allocation for the PDSCH communication. Also as part of the second step of the four-step random access procedure, the network node 110 may transmit the PDSCH communication for the RAR, as scheduled by the PDCCH communication. The RAR may be included in a MAC protocol data unit (PDU) of the PDSCH communication.

As shown by reference number 320, the UE 120 may transmit an RRC connection request message. The RRC connection request message may be referred to as message 3, msg3, MSG3, or a third message of a four-step random access procedure. In some aspects, the RRC connection request may include a UE identifier, UCI, and/or a PUSCH communication (e.g., an RRC connection request).

As shown by reference number 325, the network node 110 may transmit an RRC connection setup message. The RRC connection setup message may be referred to as message 4, msg4, MSG4, or a fourth message of a four-step random access procedure. In some aspects, the RRC connection setup message may include the detected UE identifier, a timing advance value, and/or contention resolution information. As shown by reference number 330, if the UE 120 successfully receives the RRC connection setup message, the UE 120 may transmit a hybrid automatic repeat request (HARQ) acknowledgement (ACK).

As indicated above, FIG. 3 is provided as an example. Other examples may differ from what is described with regard to FIG. 3.

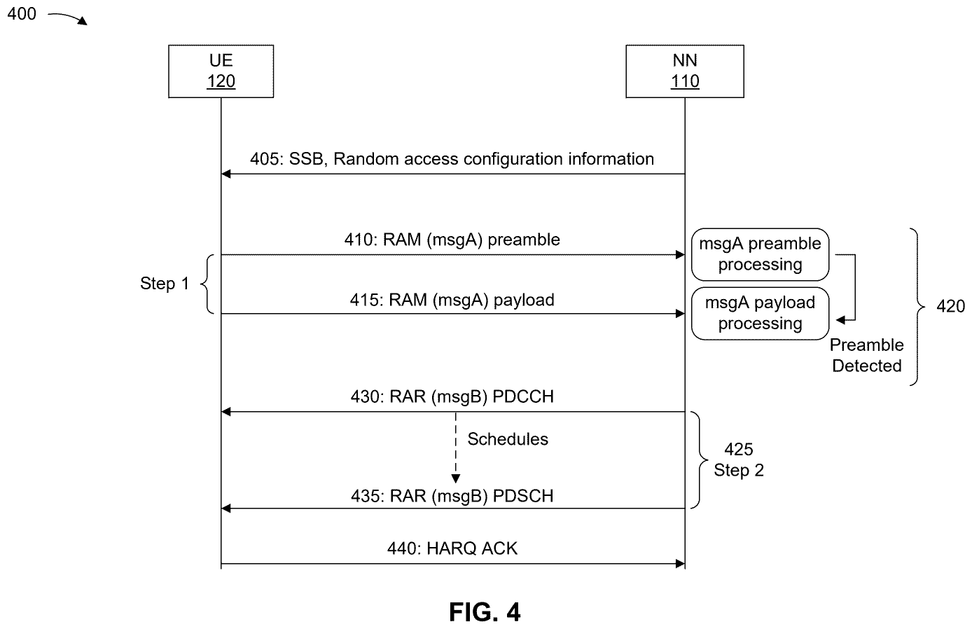

FIG. 4 is a diagram illustrating an example 400 of a two-step random access procedure, in accordance with the present disclosure. As shown in FIG. 4, a network node 110 and a UE 120 may communicate with one another to perform the two-step random access procedure.

As shown by reference number 405, the network node 110 may transmit, and the UE 120 may receive, one or more SSBs and random access configuration information. In some aspects, the random access configuration information may be transmitted in and/or indicated by system information (e.g., in one or more SIBs) and/or an SSB, such as for CBRA. Additionally, or alternatively, the random access configuration information may be transmitted in an RRC message and/or a PDCCH order message that triggers a RACH procedure, such as for CFRA. The random access configuration information may include one or more parameters to be used in the two-step random access procedure, such as one or more parameters for transmitting a RAM and/or receiving an RAR responsive to the RAM (e.g., a PRACH configuration index that corresponds to a specific PRACH period, frequency and time resources associated with one or more ROs, a number of SSBs per RO and contention-based preambles per SSB, and/or a duration for an RAR response window, and/or among other examples).

As shown by reference number 410, the UE 120 may transmit, and the network node 110 may receive, a RAM preamble. As shown by reference number 415, the UE 120 may transmit, and the network node 110 may receive, a RAM payload. As shown, the UE 120 may transmit the RAM preamble and the RAM payload to the network node 110 as part of an initial (or first) step of the two-step random access procedure. In some aspects, the RAM may be referred to as message A, msgA, a first message, or an initial message in a two-step random access procedure. Furthermore, in some aspects, the RAM preamble may be referred to as a message A preamble, a msgA preamble, a preamble, or a PRACH preamble, and the RAM payload may be referred to as a message A payload, a msgA payload, or a payload. In some aspects, the RAM may include some or all of the contents of message 1 (msg1) and message 3 (msg3) of a four-step random access procedure, which is described in more detail below. For example, the RAM preamble may include some or all contents of message 1 (e.g., a PRACH preamble), and the RAM payload may include some or all contents of message 3 (e.g., a UE identifier, UCI, and/or a PUSCH transmission).

As shown by reference number 420, the network node 110 may receive the RAM preamble transmitted by the UE 120. If the network node 110 successfully receives and decodes the RAM preamble, the network node 110 may then receive and decode the RAM payload.

As shown by reference number 425, the network node 110 may transmit an RAR (sometimes referred to as an RAR message). As shown, the network node 110 may transmit the RAR message as part of a second step of the two-step random access procedure. In some aspects, the RAR message may be referred to as message B, msgB, or a second message in a two-step random access procedure. The RAR message may include some or all of the contents of message 2 (msg2) and message 4 (msg4) of a four-step random access procedure. For example, the RAR message may include the detected RAPID, the detected UE identifier, a timing advance value, and/or contention resolution information.

As shown by reference number 430, as part of the second step of the two-step random access procedure, the network node 110 may transmit a PDCCH communication for the RAR. The PDCCH communication may schedule a PDSCH communication that includes the RAR. For example, the PDCCH communication may indicate a resource allocation (e.g., in DCI) for the PDSCH communication.

As shown by reference number 435, as part of the second step of the two-step random access procedure, the network node 110 may transmit the PDSCH communication for the RAR, as scheduled by the PDCCH communication. The RAR may be included in a MAC PDU of the PDSCH communication. As shown by reference number 440, if the UE 120 successfully receives the RAR, the UE 120 may transmit a HARQ ACK.

As indicated above, FIG. 4 is provided as an example. Other examples may differ from what is described with regard to FIG. 4.

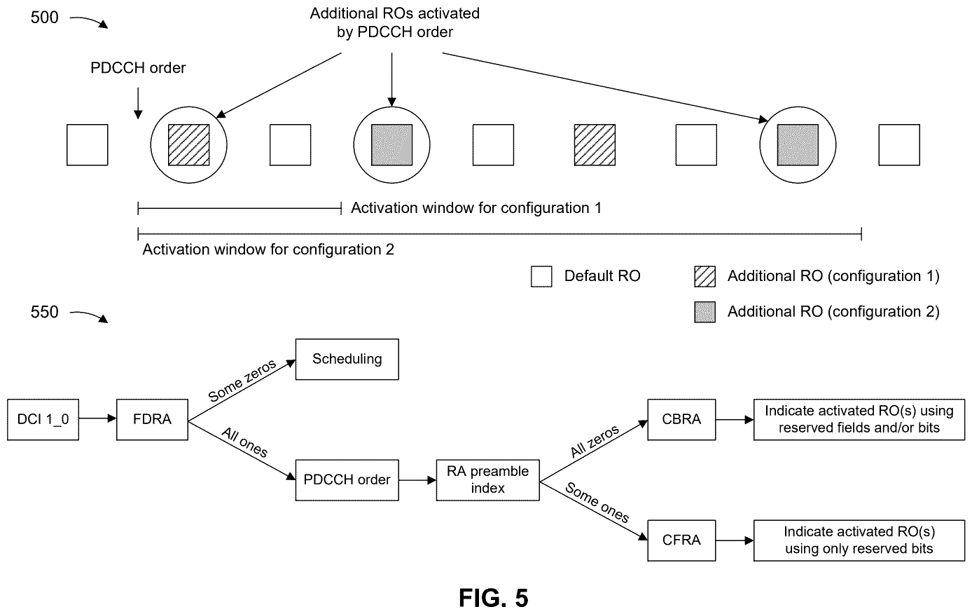

FIG. 5 is a diagram illustrating an example 500 associated with a PDCCH order adapting PRACH resources and an example 550 associated with an interpretation for the PDCCH order, in accordance with the present disclosure. In particular, as described herein, example 500 and example 550 relate to techniques to enable PRACH adaptation in a time domain to enable network energy savings. For example, as shown by example 500, a network node 110 may provide a default always-on PRACH configuration (e.g., indicated in a SIB or an SSB using a RACH-ConfigCommon parameter, a RACH-ConfigGeneric parameter, or the like, or using a UE-dedicated signaling such as a RACH-ConfigDedicated parameter) that configures relatively few default PRACH resources (e.g., default ROs in which a UE 120 can transmit a PRACH message), and the network node 110 may semi-statically configure additional PRACH resources for one or more UEs 120 (e.g., UEs 120 that have capabilities to support network energy savings features implemented by the network node 110). For example, the network node 110 may configure (e.g., via semi-static signaling) one or more additional PRACH resources for one or more UEs 120 operating in an RRC connected mode or an RRC idle/inactive mode, and the additional PRACH resources may initially be in a deactivated state. For instance, in example 500, the network node 110 may semi-statically configure a first additional PRACH configuration (shown by a diagonal fill) and a second additional PRACH configuration (shown by a solid gray fill) that are each associated with one or more ROs in addition to the default ROs. In some aspects (e.g., as shown in example 500) the additional ROs may be separate from the default ROs. Alternatively, in some aspects, one or more additional ROs may overlap with the default ROs indicated in the default PRACH configuration.

Accordingly, to enable network energy savings via PRACH adaptation in a time domain, the network node 110 may always monitor the default PRACH resources (e.g., to detect PRACH messages from UEs 120 attempting to acquire initial access to the cell or enter a connected mode on the cell), and may monitor the additional PRACH resources only when the additional PRACH resources have been activated for one or more UEs 120. For instance, as shown by example 500, the network node 110 may dynamically activate the additional PRACH resources for a UE 120 in an RRC connected mode or an RRC idle/inactive mode in a PDCCH order that triggers CBRA or CFRA, and the network node 110 may then monitor the dynamically activated PRACH resources for a PRACH message from the UE. In some aspects, the PDCCH order may be indicated in a DCI message that has a particular format (e.g., DCI format 1_0) and a cyclic redundancy code (CRC) scrambled by a cell radio network temporary identifier (C-RNTI).

In some aspects, as shown by example 550, a UE 120 may interpret a DCI message associated with DCI format 1_0 and a CRC scrambled by a C-RNTI according to values associated with one or more fields. For example, a DCI message associated with DCI format 1_0 and a CRC scrambled by a C-RNTI generally includes a frequency domain resource assignment (FDRA) field having a variable length, a random access preamble index field with a 6-bit length, an uplink or supplemental uplink indicator field having a 1-bit length, an SSB index field having a 6-bit length, and a PRACH mask index field having a 4-bit length. In addition, the DCI message includes several reserved bits (e.g., 12 bits for operation in a cell with shared spectrum channel access, or 10 bits for operation in a cell without shared spectrum channel access). As shown by example 550, the UE 120 may interpret the DCI message to be a PDCCH order that triggers a RACH procedure if each bit in the FDRA field is set to one, and may otherwise interpret the DCI message to indicate PDSCH scheduling information if one or more bits in the FDRA field are set to zero. Furthermore, when the DCI message is interpreted to be a PDCCH order, the DCI message may trigger CBRA when each bit in the random access preamble index field is set to zero, or may otherwise trigger CFRA when one or more bits in the random access preamble index field are set to one. In cases where the random access preamble index field is not all zeros (e.g., the PDCCH order triggers CFRA), the uplink or supplemental uplink indicator field indicates which uplink carrier the UE 120 is to use for the PRACH transmission, the SSB index field indicates the SSB used to determine the RO for the PRACH transmission, and the PRACH mask index field indicates the RO associated with the SSB indicated in the SSB index field. Alternatively, when the random access preamble index field is all zeros (e.g., the PDCCH order triggers CBRA), the uplink or supplemental uplink indicator field, the SSB index field, and the PRACH mask index field are reserved.

In other words, when the FDRA field is all ones and the random access preamble index is not all zeros (the DCI message is a PDCCH order triggering CFRA), the UE 120 transmits the PRACH in the RO indicated by the SSB index and PRACH mask index fields (and using the random access preamble indicated in the random access preamble index field). Alternatively, when the FDRA field is all ones and the random access preamble index is all zeros (the DCI message is a PDCCH order triggering CFRA), the UE 120 transmits the PRACH in an RO associated with a measured SSB. In cases where one or more additional ROs are configured for a UE 120 (in addition to the default ROs indicated in the default PRACH configuration), the UE 120 may use the additional ROs and the default ROs for the PRACH transmission. Accordingly, when the PDCCH order triggering a RACH procedure is also used to dynamically activate one or more additional ROs, the UE 120 may determine how to interpret the PDCCH order to determine which additional ROs are activated, and/or how long the additional ROs are activated. For example, when a PDCCH order triggers a RACH procedure for a UE 120 in an RRC connected mode or an RRC idle/inactive mode, certain fields in the PDCCH order may be interpreted differently depending on whether the PDCCH order triggers CBRA or CFRA.

For example, as shown by example 550, when the random access preamble index field is all zeros, indicating that the PDCCH order triggers CBRA, the additional ROs that are activated by the PDCCH order and/or the activation/deactivation window associated with the additional ROs (e.g., the time period during which the additional ROs are activated and/or the time period after which the additional ROs return to a deactivated state) may be indicated in one or more of the reserved fields (e.g., the uplink or supplemental uplink indicator field, the SSB index field, and/or the PRACH mask index field) or the reserved bits of the PDCCH order. Alternatively, when the random access preamble index field includes one or more ones, indicating that the PDCCH order triggers CFRA, the uplink or supplemental uplink indicator field, the SSB index field, and the PRACH mask index field are used to indicate parameters associated with the PRACH transmission. Accordingly, when the PDCCH order triggers CFRA, the additional ROs that are activated by the PDCCH order and/or the activation/deactivation window associated with the additional ROs may be indicated only using the reserved bits of the PDCCH order. Additionally, or alternatively, when the PDCCH order triggers CFRA, the SSB index field can indicate that additional ROs mapped to the SSB index indicated in the SSB index field are activated.

In some aspects, the network node 110 may transmit, and a UE 120 may receive, a semi-static parameter (e.g., a parameter associated with an RRC configuration) that indicates whether a PDCCH order triggering a RACH procedure can be used to activate additional PRACH resources. For example, when the semi-static parameter indicates that a PDCCH order triggering a RACH procedure cannot activate additional PRACH resources, a UE 120 that receives a PDCCH order triggering a RACH procedure may transmit a PRACH in a default RO associated with a default PRACH configuration. Alternatively, when the semi-static parameter indicates that a PDCCH order triggering a RACH procedure can activate additional PRACH resources, a UE 120 that receives a PDCCH order triggering a RACH procedure may interpret the PDCCH order to determine which additional PRACH resources are activated, depending on whether the PDCCH order triggers CBRA (e.g., the additional PRACH resources that are activated are indicated in the uplink/supplemental indicator field, the SSB index field, the PRACH mask index field, and/or the reserved bits) or CFRA (e.g., the additional PRACH resources that are activated are indicated in the reserved bits and/or the SSB index field may activate additional PRACH resources mapped to the indicated SSB index). Furthermore, in cases where the UE 120 is configured with multiple additional PRACH resources and/or additional PRACH configurations, the semi-static parameter may indicate the additional PRACH resource(s) and/or the additional PRACH configuration(s) that can be activated by the PDCCH order. Alternatively, in some aspects, the PDCCH order that dynamically activates the additional PRACH resources may select between the multiple additional PRACH resources and/or the multiple additional PRACH configurations.

In some aspects, in cases where the UE 120 is configured with multiple additional PRACH configurations (e.g., as shown in example 500), each additional PRACH configuration may be configured with an activation window (e.g., a time period, or a number of PRACH configuration periods, during which the additional PRACH configuration remains activated following a PDCCH order that activates the additional PRACH configuration). For instance, in example 500, the first additional PRACH configuration is associated with a first activation window that spans a first time period, or a first number of PRACH configuration periods, and the second additional PRACH configuration is associated with a second activation window that spans a second time period, or a second number of PRACH configuration periods. In this way, depending on the periodicity of the additional PRACH resources, the number of additional PRACH resources that are associated with an additional PRACH configuration activated by a PDCCH order may vary depending on the length of the activation window associated with the additional PRACH configuration.

In some aspects, the network node 110 may transmit, and a UE 120 may receive, a semi-static parameter (e.g., a parameter associated with an RRC configuration) that indicates whether a PDCCH order triggering a RACH procedure can implicitly activate additional PRACH resources. For example, when the semi-static parameter indicates that a PDCCH order triggering a RACH procedure can implicitly activate additional PRACH resources that are configured, a UE 120 that receives a PDCCH order triggering a RACH procedure may determine that any additional PRACH resources that are configured for the UE 120 are activated by the PDCCH order. In this way, the PDCCH order may not have any explicit indicator for the additional PRACH resources that are dynamically activated, which may reduce signaling overhead associated with the PDCCH order and/or reduce complexity at the network node 110 and the UE 120 (e.g., because the network node 110 does not need to signal or indicate any information related to the additional PRACH resources that are activated by the PDCCH order, and the UE 120 can assume that the PDCCH order activates any additional PRACH resources that have been configured without having to interpret the various fields associated with the PDCCH order).

As indicated above, FIG. 5 is provided as an example. Other examples may differ from what is described with respect to FIG. 5.

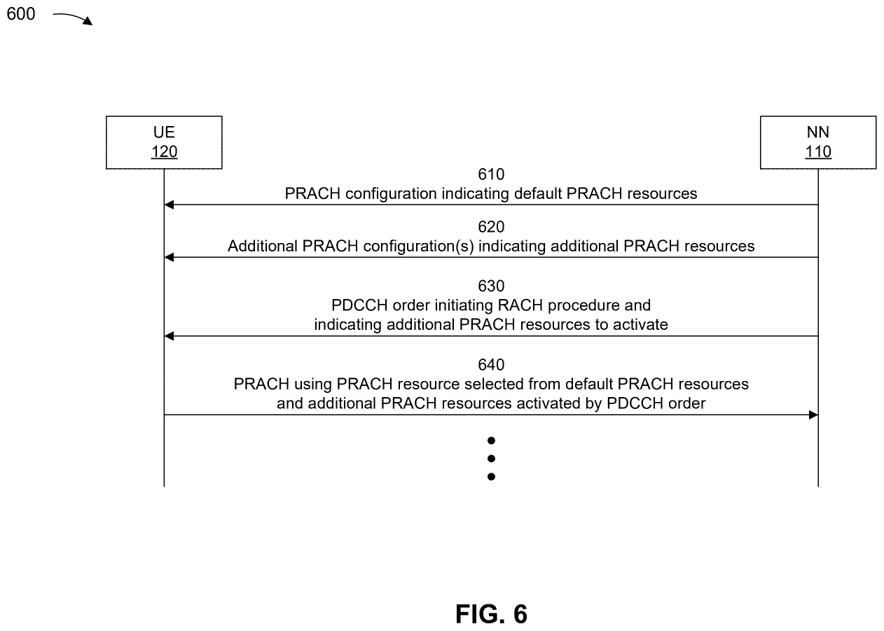

FIG. 6 is a diagram illustrating an example call flow 600 associated with a PDCCH order adapting PRACH resources, in accordance with the present disclosure. As shown in FIG. 6, example 600 includes communication between a network node 110 and a UE 120 in a wireless network, such as wireless network 100. The network node 110 and the UE 120 may communicate via a wireless access link.

As shown by reference number 610, the network node 110 may transmit, and the UE 120 may receive, a PRACH configuration that indicates a set of default PRACH resources. For example, the PRACH configuration that indicates the default PRACH resources may be provided in a default always-on PRACH configuration (e.g., indicated in a SIB or an SSB using a RACH-ConfigCommon parameter, a RACH-ConfigGeneric parameter, or the like, or using UE-dedicated signaling, such as a RACH-ConfigDedicated parameter) that configures relatively few default PRACH resources (e.g., default ROs that are always available for the UE 120 to transmit a PRACH message). For example, the PRACH configuration that indicates the default PRACH resources may indicate PRACH transmission parameters such as a PRACH preamble format, PRACH resources in a time domain, PRACH resources in a frequency domain, a preamble subcarrier spacing, and/or parameters for determining root sequences and cyclic shifts in the PRACH preamble sequence set, among other examples. In some aspects, the network node 110 may be configured to always monitor the default PRACH resources indicated in the default PRACH configuration (e.g., to detect PRACH messages from UEs 120 that may be attempting to acquire initial access to the cell or enter a connected mode on the cell, among other examples).

As shown by reference number 620, the network node 110 may transmit, and the UE 120 may receive, one or more additional PRACH configurations that indicate additional PRACH resources that are configured for the UE 120 (e.g., in accordance with the UE 120 having capabilities to support network energy savings features implemented by the network node 110). For example, in some aspects, the network node 110 may configure (e.g., via RRC or other semi-static signaling) one or more additional PRACH resources when the UE 120 is operating in an RRC connected mode or an RRC idle/inactive mode, and the additional PRACH resources may initially be in a deactivated state. For instance, the network node 110 may semi-statically configure one or more additional PRACH configurations that are each associated with one or more additional PRACH resources (in addition to the default PRACH resources configured by the default PRACH configuration). In some aspects, the additional ROs may be separate from the default PRACH resources, or the additional PRACH resources may overlap with the default PRACH resources in the default PRACH configuration.

Accordingly, to enable network energy savings via PRACH adaptation in a time domain, the network node 110 may always monitor the default PRACH resources (e.g., to detect PRACH messages from the UE 120 or any other UEs 120 that may be attempting to acquire initial access to the cell or enter a connected mode on the cell), and the network node 110 may monitor additional PRACH resources that have been configured only when the additional PRACH resources have been dynamically activated for one or more UEs 120. For instance, as shown by reference number 630, the network node 110 may transmit, and the UE 120 may receive, a PDCCH order that triggers CBRA or CFRA and dynamically activates the additional PRACH resources. In some aspects, the network node 110 may then monitor the dynamically activated PRACH resources for a PRACH message from the UE 120 in addition to the default PRACH resources that are always activated. In some aspects, the PDCCH order may be indicated in a DCI message that has a particular format (e.g., DCI format 1_0) and a CRC scrambled by a C-RNTI.

In some aspects, when the UE 120 receives a DCI message associated with DCI format 1_0 and a CRC scrambled by a C-RNTI from the network node 110, the UE 120 may interpret the DCI message according to values associated with one or more fields included therein. For example, a DCI message associated with DCI format 1_0 and a CRC scrambled by a C-RNTI generally includes an FDRA field having a variable length, a random access preamble index field with a 6-bit length, an uplink or supplemental uplink indicator field having a 1-bit length, an SSB index field having a 6-bit length, and a PRACH mask index field having a 4-bit length. In addition, the DCI message includes several reserved bits (e.g., 12 bits for operation in a cell with shared spectrum channel access, or 10 bits for operation in a cell without shared spectrum channel access). Accordingly, the UE 120 may interpret the DCI message to be a PDCCH order that triggers a RACH procedure if each bit in the FDRA field is set to one, and may otherwise interpret the DCI message to indicate PDSCH scheduling information if one or more bits in the FDRA field are set to zero. Furthermore, when the DCI message is interpreted to be a PDCCH order, the DCI message may trigger CBRA when each bit in the random access preamble index field is set to zero, or may otherwise trigger CFRA when one or more bits in the random access preamble index field are set to one. In cases where the random access preamble index field is not all zeros (e.g., the PDCCH order triggers CFRA), the uplink or supplemental uplink indicator field indicates which uplink carrier the UE 120 is to use for the PRACH transmission, the SSB index field indicates the SSB used to determine the RO for the PRACH transmission, and the PRACH mask index field indicates the RO associated with the SSB indicated in the SSB index field. Alternatively, when the random access preamble index field is all zeros (e.g., the PDCCH order triggers CBRA), the uplink or supplemental uplink indicator field, the SSB index field, and the PRACH mask index field are reserved.

Accordingly, as shown by reference number 640, the UE 120 may transmit, and the network node 110 may receive, a PRACH message that initiates a RACH procedure (e.g., msg1 in a four-step RACH procedure or a msgA preamble in a two-step RACH procedure) using a PRACH resource selected from the default PRACH resources and the additional PRACH resources that were dynamically activated by the PDCCH order. For example, when the FDRA field of the DCI message is all ones and the random access preamble index is not all zeros (the DCI message is a PDCCH order triggering CFRA), the UE 120 transmits the PRACH using a PRACH resource indicated by the SSB index field and the PRACH mask index field (and using the random access preamble indicated in the random access preamble index field). Alternatively, when the FDRA field is all ones and the random access preamble index is all zeros (the DCI message is a PDCCH order triggering CFRA), the UE 120 transmits the PRACH using a PRACH resource associated with a measured SSB. In cases where one or more additional ROs are configured and dynamically activated for the UE 120, the UE 120 may use the additional PRACH resources and/or the default PRACH resources for the PRACH transmission. Accordingly, when the PDCCH order triggering a RACH procedure dynamically activates one or more additional PRACH resources, the UE 120 may interpret the PDCCH order to determine which additional PRACH resources are activated and/or how long the additional PRACH resources are activated.

For example, when the random access preamble index field is all zeros, indicating that the PDCCH order triggers CBRA, the additional PRACH resources that are activated by the PDCCH order and/or the activation/deactivation window associated with the additional PRACH resources (e.g., the time period during which the additional PRACH resources are activated and/or the time period after which the additional PRACH resources return to a deactivated state) may be indicated in one or more of the reserved fields (e.g., the uplink or supplemental uplink indicator field, the SSB index field, and/or the PRACH mask index field) or the reserved bits of the PDCCH order. Alternatively, when the random access preamble index field includes one or more ones, indicating that the PDCCH order triggers CFRA, the uplink or supplemental uplink indicator field, the SSB index field, and the PRACH mask index field are used to indicate parameters associated with the PRACH transmission. Accordingly, when the PDCCH order triggers CFRA, the additional PRACH resources that are activated by the PDCCH order and/or the activation/deactivation window associated with the additional PRACH resources may be indicated only using the reserved bits of the PDCCH order. Additionally, or alternatively, when the PDCCH order triggers CFRA, the SSB index field can indicate that additional PRACH resources mapped to the SSB index indicated in the SSB index field are activated.

In some aspects, the network node 110 may transmit, and a UE 120 may receive, a semi-static parameter (e.g., a parameter associated with an RRC configuration) that indicates whether a PDCCH order triggering a RACH procedure can be used to activate additional PRACH resources. For example, the semi-static parameter that indicates whether a PDCCH order can be used to activate additional PRACH resources may be included with one or more of the additional PRACH configurations that are semi-statically configured, or configured separately. In some aspects, when the semi-static parameter indicates that a PDCCH order triggering a RACH procedure cannot activate additional PRACH resources, the UE 120 may transmit the PRACH message in default PRACH resources associated with the default PRACH configuration. Alternatively, when the semi-static parameter indicates that the PDCCH order triggering the RACH procedure can activate additional PRACH resources, the UE 120 may interpret the PDCCH order to determine which additional PRACH resources are activated depending on whether the PDCCH order triggers CBRA or CFRA. Furthermore, in cases where the UE 120 is configured with multiple additional PRACH resources and/or additional PRACH configurations, the semi-static parameter may indicate the additional PRACH resource(s) and/or the additional PRACH configuration(s) that can be activated by the PDCCH order. Alternatively, in some aspects, the PDCCH order that dynamically activates the additional PRACH resources may select between the multiple additional PRACH resources and/or the multiple additional PRACH configurations.

In some aspects, in cases where the UE 120 is configured with multiple additional PRACH configurations, each additional PRACH configuration may be configured with an activation window (e.g., a time period, or a number of PRACH configuration periods, during which the additional PRACH configuration remains activated following a PDCCH order that activates the additional PRACH configuration). For instance, a first additional PRACH configuration may be associated with a first activation window that spans a first time period, or a first number of PRACH configuration periods (e.g., two PRACH configuration periods), and a second additional PRACH configuration may be associated with a second activation window that spans a second time period, or a second number of PRACH configuration periods (e.g., four PRACH configuration periods). In this way, depending on the periodicity of the additional PRACH resources, the number of additional PRACH resources that are activated by a PDCCH order may vary depending on the length of the activation window associated with the additional PRACH configuration.

In some aspects, the network node 110 may transmit, and a UE 120 may receive, a semi-static parameter (e.g., a parameter associated with an RRC configuration) that indicates whether a PDCCH order triggering a RACH procedure can implicitly activate additional PRACH resources. For example, the semi-static parameter that indicates whether a PDCCH order triggering a RACH procedure can implicitly activate additional PRACH resources may be included with one or more of the additional PRACH configurations that are semi-statically configured, or configured separately. In some aspects, when the semi-static parameter indicates that a PDCCH order triggering a RACH procedure can implicitly activate additional PRACH resources that are configured, the UE 120 may determine that any additional PRACH resources that are configured for the UE 120 are activated by the PDCCH order. In this way, the PDCCH order may not have any explicit indicator for the additional PRACH resources that are dynamically activated, which may reduce signaling overhead associated with the PDCCH order and/or reduce complexity at the network node 110 and the UE 120 (e.g., because the network node 110 does not need to signal or indicate any information related to the additional PRACH resources that are activated by the PDCCH order, and the UE 120 can assume that the PDCCH order activates any additional PRACH resources that have been configured without having to interpret the various fields associated with the PDCCH order).

As indicated above, FIG. 6 is provided as an example. Other examples may differ from what is described with respect to FIG. 6.

FIG. 7 is a diagram illustrating an example process 700 performed, for example, at a UE or an apparatus of a UE, in accordance with the present disclosure. Example process 700 is an example where the apparatus or the UE (e.g., UE 120) performs operations associated with an interpretation for a PDCCH order adapting PRACH resources.

As shown in FIG. 7, in some aspects, process 700 may include receiving, from a network node, a default PRACH configuration that indicates one or more default PRACH resources (block 710). For example, the UE (e.g., using reception component 902 and/or communication manager 906, depicted in FIG. 9) may receive, from a network node, a default PRACH configuration that indicates one or more default PRACH resources, as described above.

As further shown in FIG. 7, in some aspects, process 700 may include receiving, from the network node, an additional PRACH configuration that configures one or more additional PRACH resources (block 720). For example, the UE (e.g., using reception component 902 and/or communication manager 906, depicted in FIG. 9) may receive, from the network node, an additional PRACH configuration that configures one or more additional PRACH resources, as described above.

As further shown in FIG. 7, in some aspects, process 700 may include receiving, from the network node, a PDCCH order that initiates a RACH procedure and indicates a subset of the one or more additional PRACH resources to activate (block 730). For example, the UE (e.g., using reception component 902 and/or communication manager 906, depicted in FIG. 9) may receive, from the network node, a PDCCH order that initiates a RACH procedure and indicates a subset of the one or more additional PRACH resources to activate, as described above.

As further shown in FIG. 7, in some aspects, process 700 may include transmitting, to the network node, a PRACH message using a PRACH resource selected from the one or more default PRACH resources and the subset of the one or more additional PRACH resources in accordance with the PDCCH order (block 740). For example, the UE (e.g., using transmission component 904 and/or communication manager 906, depicted in FIG. 9) may transmit, to the network node, a PRACH message using a PRACH resource selected from the one or more default PRACH resources and the subset of the one or more additional PRACH resources in accordance with the PDCCH order, as described above.

Process 700 may include additional aspects, such as any single aspect or any combination of aspects described below and/or in connection with one or more other processes described elsewhere herein.

In a first aspect, the subset of the one or more additional PRACH resources to activate are indicated by one or more reserved fields or a set of reserved bits in the PDCCH order based on the PDCCH order initiating CBRA.

In a second aspect, alone or in combination with the first aspect, the subset of the one or more additional PRACH resources to activate are indicated by a set of reserved bits in the PDCCH order based on the PDCCH order initiating CFRA.

In a third aspect, alone or in combination with one or more of the first and second aspects, the subset of the one or more additional PRACH resources to activate is mapped to an SSB index indicated in an SSB index field of the PDCCH order based on the PDCCH order initiating CFRA.

In a fourth aspect, alone or in combination with one or more of the first through third aspects, process 700 includes receiving, from the network node, a semi-static configuration that enables activation of additional PRACH resources by the PDCCH order.

In a fifth aspect, alone or in combination with one or more of the first through fourth aspects, process 700 includes receiving, from the network node, a semi-static configuration that enables activation of the subset of the one or more additional PRACH resources by the PDCCH order.

In a sixth aspect, alone or in combination with one or more of the first through fifth aspects, the PDCCH order activates the subset of the one or more additional PRACH resources for an activation window that includes a number of PRACH configuration periods.

In a seventh aspect, alone or in combination with one or more of the first through sixth aspects, process 700 includes receiving, from the network node, a semi-static configuration that enables implicit activation of additional PRACH resources that are configured via the PDCCH order.

In an eighth aspect, alone or in combination with one or more of the first through seventh aspects, the default PRACH configuration is an always-on PRACH configuration and the one or more default PRACH resources are always-on PRACH resources.

In a ninth aspect, alone or in combination with one or more of the first through eighth aspects, the additional PRACH configuration is based at least in part on the UE supporting network energy savings features implemented by the network node.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a network node or an apparatus of a network node, in accordance with the present disclosure. Example process 800 is an example where the apparatus or the network node (e.g., network node 110) performs operations associated with an interpretation for a PDCCH order adapting PRACH resources.

As shown in FIG. 8, in some aspects, process 800 may include transmitting, to a UE, a default PRACH configuration that indicates one or more default PRACH resources (block 810). For example, the network node (e.g., using transmission component 1004 and/or communication manager 1006, depicted in FIG. 10) may transmit, to a UE, a default PRACH configuration that indicates one or more default PRACH resources, as described above.

As further shown in FIG. 8, in some aspects, process 800 may include transmitting, to the UE, an additional PRACH configuration that configures one or more additional PRACH resources (block 820). For example, the network node (e.g., using transmission component 1004 and/or communication manager 1006, depicted in FIG. 10) may transmit, to the UE, an additional PRACH configuration that configures one or more additional PRACH resources, as described above.

As further shown in FIG. 8, in some aspects, process 800 may include transmitting, to the UE, a PDCCH order that initiates a RACH procedure and indicates a subset of the one or more additional PRACH resources to activate (block 830). For example, the network node (e.g., using transmission component 1004 and/or communication manager 1006, depicted in FIG. 10) may transmit, to the UE, a PDCCH order that initiates a RACH procedure and indicates a subset of the one or more additional PRACH resources to activate, as described above.

As further shown in FIG. 8, in some aspects, process 800 may include receiving, from the UE, a PRACH message using a PRACH resource selected from the one or more default PRACH resources and the subset of the one or more additional PRACH resources in accordance with the PDCCH order (block 840). For example, the network node (e.g., using reception component 1002 and/or communication manager 1006, depicted in FIG. 10) may receive, from the UE, a PRACH message using a PRACH resource selected from the one or more default PRACH resources and the subset of the one or more additional PRACH resources in accordance with the PDCCH order, as described above.

Process 800 may include additional aspects, such as any single aspect or any combination of aspects described below and/or in connection with one or more other processes described elsewhere herein.

In a first aspect, the subset of the one or more additional PRACH resources to activate are indicated by one or more reserved fields or a set of reserved bits in the PDCCH order based on the PDCCH order initiating CBRA.

In a second aspect, alone or in combination with the first aspect, the subset of the one or more additional PRACH resources to activate are indicated by a set of reserved bits in the PDCCH order based on the PDCCH order initiating CFRA.

In a third aspect, alone or in combination with one or more of the first and second aspects, the subset of the one or more additional PRACH resources to activate is mapped to an SSB index indicated in an SSB index field of the PDCCH order based on the PDCCH order initiating CFRA.

In a fourth aspect, alone or in combination with one or more of the first through third aspects, process 800 includes transmitting, to the UE, a semi-static configuration that enables activation of additional PRACH resources by the PDCCH order.

In a fifth aspect, alone or in combination with one or more of the first through fourth aspects, process 800 includes transmitting, to the UE, a semi-static configuration that enables activation of the subset of the one or more additional PRACH resources by the PDCCH order.

In a sixth aspect, alone or in combination with one or more of the first through fifth aspects, the PDCCH order activates the subset of the one or more additional PRACH resources for an activation window that includes a number of PRACH configuration periods.

In a seventh aspect, alone or in combination with one or more of the first through sixth aspects, process 800 includes transmitting, to the UE, a semi-static configuration that enables implicit activation of additional PRACH resources that are configured via the PDCCH order.

In an eighth aspect, alone or in combination with one or more of the first through seventh aspects, the default PRACH configuration is an always-on PRACH configuration and the one or more default PRACH resources are always-on PRACH resources.

In a ninth aspect, alone or in combination with one or more of the first through eighth aspects, the additional PRACH configuration is based at least in part on the UE supporting network energy savings features implemented by the network node.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 140 described in connection with FIG. 1) of the UE.

In some aspects, the apparatus 900 may be configured to perform one or more operations described herein in connection with FIGS. 5-6. Additionally, or alternatively, the apparatus 900 may be configured to perform one or more processes described herein, such as process 700 of FIG. 7. In some aspects, the apparatus 900 and/or one or more components shown in FIG. 9 may include one or more components of the UE described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the UE described above in connection with FIG. 1, such as a radio, one or more RF chains, one or more transceivers, or one or more modems, each of which may in turn be coupled with one or more antennas of the UE.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 904 may be co-located with the reception component 902.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The reception component 902 may receive, from a network node, a default PRACH configuration that indicates one or more default PRACH resources. The reception component 902 may receive, from the network node, an additional PRACH configuration that configures one or more additional PRACH resources. The reception component 902 may receive, from the network node, a PDCCH order that initiates a RACH procedure and indicates a subset of the one or more additional PRACH resources to activate. The transmission component 904 may transmit, to the network node, a PRACH message using a PRACH resource selected from the one or more default PRACH resources and the subset of the one or more additional PRACH resources in accordance with the PDCCH order.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a network node, or a network node may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 155 described in connection with FIG. 1. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 145 described in connection with FIG. 1) of the network node.

In some aspects, the apparatus 1000 may be configured to perform one or more operations described herein in connection with FIGS. 5-6. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the network node described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the network node described above in connection with FIG. 1, such as a radio, one or more RF chains, one or more transceivers, or one or more modems, each of which may in turn be coupled with one or more antennas of the network node. In some aspects, the reception component 1002 and/or the transmission component 1004 may include or may be included in a network interface. The network interface may be configured to obtain and/or output signals for the apparatus 1000 via one or more communications links, such as a backhaul link, a midhaul link, and/or a fronthaul link.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1004 may be co-located with the reception component 1002.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The transmission component 1004 may transmit, to a UE, a default PRACH configuration that indicates one or more default PRACH resources. The transmission component 1004 may transmit, to the UE, an additional PRACH configuration that configures one or more additional PRACH resources. The transmission component 1004 may transmit, to the UE, a PDCCH order that initiates a RACH procedure and indicates a subset of the one or more additional PRACH resources to activate. The reception component 1002 may receive, from the UE, a PRACH message using a PRACH resource selected from the one or more default PRACH resources and the subset of the one or more additional PRACH resources in accordance with the PDCCH order.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a UE, comprising: receiving, from a network node, a default PRACH configuration that indicates one or more default PRACH resources; receiving, from the network node, an additional PRACH configuration that configures one or more additional PRACH resources; receiving, from the network node, a PDCCH order that initiates a RACH procedure and indicates a subset of the one or more additional PRACH resources to activate; and transmitting, to the network node, a PRACH message using a PRACH resource selected from the one or more default PRACH resources and the subset of the one or more additional PRACH resources in accordance with the PDCCH order.

Aspect 2: The method of Aspect 1, wherein the PDCCH order includes one or more reserved fields or a set of reserved bits that indicate the subset of the one or more additional PRACH resources to activate based on the PDCCH order initiating CBRA.

Aspect 3: The method of any of Aspects 1-2, wherein the PDCCH order includes a set of reserved bits that indicate the subset of the one or more additional PRACH resources to activate based on the PDCCH order initiating CFRA.

Aspect 4: The method of any of Aspects 1-3, wherein the subset of the one or more additional PRACH resources to activate is mapped to an SSB index indicated in an SSB index field of the PDCCH order based on the PDCCH order initiating CFRA.

Aspect 5: The method of any of Aspects 1-4, further comprising: receiving, from the network node, a semi-static configuration that indicates whether the PDCCH order can activate additional PRACH resources, wherein the PDCCH order indicates the subset of the one or more additional PRACH resources to activate in accordance with the semi-static configuration indicating that the PDCCH order can activate additional PRACH resources.

Aspect 6: The method of any of Aspects 1-5, further comprising: receiving, from the network node, a semi-static configuration that indicates that the PDCCH order can activate the subset of the one or more additional PRACH resources, wherein the PDCCH order indicates the subset of the one or more additional PRACH resources to activate in accordance with the semi-static configuration.

Aspect 7: The method of any of Aspects 1-6, wherein the PDCCH order activates the subset of the one or more additional PRACH resources for an activation window that includes a number of PRACH configuration periods.

Aspect 8: The method of any of Aspects 1-7, further comprising: receiving, from the network node, a semi-static configuration that indicates that the PDCCH order activates additional PRACH resources that are configured.

Aspect 9: The method of any of Aspects 1-8, wherein the default PRACH configuration is an always-on PRACH configuration and the one or more default PRACH resources are always-on PRACH resources.

Aspect 10: The method of any of Aspects 1-9, wherein the additional PRACH configuration is based at least in part on the UE supporting network energy savings features implemented by the network node.

Aspect 11: A method of wireless communication performed by a network node, comprising: transmitting, to a UE, a default PRACH configuration that indicates one or more default PRACH resources; transmitting, to the UE, an additional PRACH configuration that configures one or more additional PRACH resources; transmitting, to the UE, a PDCCH order that initiates a RACH procedure and indicates a subset of the one or more additional PRACH resources to activate; and receiving, from the UE, a PRACH message using a PRACH resource selected from the one or more default PRACH resources and the subset of the one or more additional PRACH resources in accordance with the PDCCH order.

Aspect 12: The method of Aspect 11, wherein the PDCCH order includes one or more reserved fields or a set of reserved bits that indicate the subset of the one or more additional PRACH resources to activate based on the PDCCH order initiating CBRA.

Aspect 13: The method of any of Aspects 11-12, wherein the PDCCH order includes a set of reserved bits that indicate the subset of the one or more additional PRACH resources to activate based on the PDCCH order initiating CFRA.

Aspect 14: The method of any of Aspects 11-13, wherein the subset of the one or more additional PRACH resources to activate is mapped to an SSB index indicated in an SSB index field of the PDCCH order based on the PDCCH order initiating CFRA.

Aspect 15: The method of any of Aspects 11-14, further comprising: transmitting, to the UE, a semi-static configuration that indicates whether the PDCCH order can activate additional PRACH resources, wherein the PDCCH order indicates the subset of the one or more additional PRACH resources to activate in accordance with the semi-static configuration indicating that the PDCCH order can activate additional PRACH resources.

Aspect 16: The method of any of Aspects 11-15, further comprising: transmitting, to the UE, a semi-static configuration that indicates that the PDCCH order can activate the subset of the one or more additional PRACH resources, wherein the PDCCH order indicates the subset of the one or more additional PRACH resources to activate in accordance with the semi-static configuration.

Aspect 17: The method of any of Aspects 11-16, wherein the PDCCH order activates the subset of the one or more additional PRACH resources for an activation window that includes a number of PRACH configuration periods.

Aspect 18: The method of any of Aspects 11-17, further comprising: transmitting, to the UE, a semi-static configuration that indicates that the PDCCH order activates additional PRACH resources that are configured.

Aspect 19: The method of any of Aspects 11-18, wherein the default PRACH configuration is an always-on PRACH configuration and the one or more default PRACH resources are always-on PRACH resources.

Aspect 20: The method of any of Aspects 11-19, wherein the additional PRACH configuration is based at least in part on the UE supporting network energy savings features implemented by the network node.

Aspect 21: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-20.

Aspect 22: An apparatus for wireless communication at a device, the apparatus comprising one or more memories and one or more processors coupled to the one or more memories, the one or more processors configured to cause the device to perform the method of one or more of Aspects 1-20.

Aspect 23: An apparatus for wireless communication, the apparatus comprising at least one means for performing the method of one or more of Aspects 1-20.

Aspect 24: A non-transitory computer-readable medium storing code for wireless communication, the code comprising instructions executable by one or more processors to perform the method of one or more of Aspects 1-20.

Aspect 25: A non-transitory computer-readable medium storing a set of instructions for wireless communication, the set of instructions comprising one or more instructions that, when executed by one or more processors of a device, cause the device to perform the method of one or more of Aspects 1-20.

Aspect 26: A device for wireless communication, the device comprising a processing system that includes one or more processors and one or more memories coupled with the one or more processors, the processing system configured to cause the device to perform the method of one or more of Aspects 1-20.

Aspect 27: An apparatus for wireless communication at a device, the apparatus comprising one or more memories and one or more processors coupled to the one or more memories, the one or more processors individually or collectively configured to cause the device to perform the method of one or more of Aspects 1-20.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, configured to cause the UE to:
receive, from a network node, a default physical random access channel (PRACH) configuration that indicates one or more default PRACH resources;
receive, from the network node, an additional PRACH configuration that configures one or more additional PRACH resources;
receive, from the network node, a physical downlink control channel (PDCCH) order that initiates a random access channel (RACH) procedure and indicates a subset of the one or more additional PRACH resources to activate; and
transmit, to the network node, a PRACH message using a PRACH resource selected from the one or more default PRACH resources and the subset of the one or more additional PRACH resources in accordance with the PDCCH order.

2. The UE of claim 1, wherein the subset of the one or more additional PRACH resources to activate are indicated by one or more reserved fields or a set of reserved bits in the PDCCH order based on the PDCCH order initiating contention-based random access.

3. The UE of claim 1, wherein the subset of the one or more additional PRACH resources to activate are indicated by a set of reserved bits in the PDCCH order based on the PDCCH order initiating contention-free random access.

4. The UE of claim 1, wherein the subset of the one or more additional PRACH resources to activate is mapped to a synchronization signal block (SSB) index indicated in an SSB index field of the PDCCH order based on the PDCCH order initiating contention-free random access.

5. The UE of claim 1, wherein the one or more processors are further configured to cause the UE to:
receive, from the network node, a semi-static configuration that enables activation of additional PRACH resources by the PDCCH order.

6. The UE of claim 1, wherein the one or more processors are further configured to cause the UE to:
receive, from the network node, a semi-static configuration that enables activation of the subset of the one or more additional PRACH resources by the PDCCH order.

7. The UE of claim 1, wherein the PDCCH order activates the subset of the one or more additional PRACH resources for an activation window that includes a number of PRACH configuration periods.

8. The UE of claim 1, wherein the one or more processors are further configured to cause the UE to:
receive, from the network node, a semi-static configuration that enables implicit activation of additional PRACH resources that are configured via the PDCCH order.

9. The UE of claim 1, wherein the default PRACH configuration is an always-on PRACH configuration and the one or more default PRACH resources are always-on PRACH resources.

10. The UE of claim 1, wherein the additional PRACH configuration is based at least in part on the UE supporting network energy savings features implemented by the network node.

11. A method of wireless communication performed by a user equipment (UE), comprising:
receiving, from a network node, a default physical random access channel (PRACH) configuration that indicates one or more default PRACH resources;
receiving, from the network node, an additional PRACH configuration that configures one or more additional PRACH resources;
receiving, from the network node, a physical downlink control channel (PDCCH) order that initiates a random access channel (RACH) procedure and indicates a subset of the one or more additional PRACH resources to activate; and
transmitting, to the network node, a PRACH message using a PRACH resource selected from the one or more default PRACH resources and the subset of the one or more additional PRACH resources in accordance with the PDCCH order.

12. The method of claim 11, wherein the subset of the one or more additional PRACH resources to activate are indicated by one or more reserved fields or a set of reserved bits in the PDCCH order based on the PDCCH order initiating contention-based random access.

13. The method of claim 11, wherein the subset of the one or more additional PRACH resources to activate are indicated by a set of reserved bits in the PDCCH order based on the PDCCH order initiating contention-free random access.

14. The method of claim 11, wherein the subset of the one or more additional PRACH resources to activate is mapped to a synchronization signal block (SSB) index indicated in an SSB index field of the PDCCH order based on the PDCCH order initiating contention-free random access.

15. The method of claim 11, comprising:
receiving, from the network node, a semi-static configuration that enables activation of additional PRACH resources by the PDCCH order.

16. The method of claim 11, wherein the PDCCH order activates the subset of the one or more additional PRACH resources for an activation window that includes a number of PRACH configuration periods.

17. An apparatus for wireless communication, comprising:
means for receiving, from a network node, a default physical random access channel (PRACH) configuration that indicates one or more default PRACH resources;
means for receiving, from the network node, an additional PRACH configuration that configures one or more additional PRACH resources;
means for receiving, from the network node, a physical downlink control channel (PDCCH) order that initiates a random access channel (RACH) procedure and indicates a subset of the one or more additional PRACH resources to activate; and
means for transmitting, to the network node, a PRACH message using a PRACH resource selected from the one or more default PRACH resources and the subset of the one or more additional PRACH resources in accordance with the PDCCH order.

18. The apparatus of claim 17, wherein the subset of the one or more additional PRACH resources to activate are indicated by one or more reserved fields or a set of reserved bits in the PDCCH order based on the PDCCH order initiating contention-based random access.

19. The apparatus of claim 17, wherein the subset of the one or more additional PRACH resources to activate are indicated by a set of reserved bits in the PDCCH order based on the PDCCH order initiating contention-free random access.

20. The apparatus of claim 17, wherein the subset of the one or more additional PRACH resources to activate is mapped to a synchronization signal block (SSB) index indicated in an SSB index field of the PDCCH order based on the PDCCH order initiating contention-free random access.
